(19) United States
(12) Patent Application Publication
(10) Pub. No.: US 2014/0023422 A1
(43) Pub. Date: Jan. 23, 2014

(54) Novel Hand Sanitizer Dispenser for Gloves

(71) Applicant: Brian Yarmeisch, Old Bethpage, NY (US)

(72) Inventor: Brian Yarmeisch, Old Bethpage, NY (US)

(21) Appl. No.: 13/551,177

(22) Filed: Jul. 17, 2012

(51) Int. Cl. B05C 21/00

(52) U.S. Cl. 401/6

(57) ABSTRACT

A foamed or open cell matrix material is attached to the palm of a glove and retains and releases hand sanitizer. The foam pad can be adhered to the glove integrally, or as a detachable accessory using mechanical or chemical adhesive systems.

### FIELD OF THE INVENTION

The field of the invention is the field of gloves and glove accessories.

### BACKGROUND OF THE INVENTION

Hand sanitizers are increasingly used to protect against pathogenic microorganisms. The gel is a gel of ethanol or other antimicrobial liquids.

Contact surfaces encountered in daily routines are often have fecal contaminants or other types of potentially harmful microorganisms.

### OBJECTS OF THE INVENTION

One object of the invention is to develop a new glove accessory. Another object of the invention is to develop a palm fitting hand sanitizer dispenser pad. Yet another object of the invention is to develop a disposable glove with a hand sanitizer pre-soaked in a palm located dispenser pad. Another object of the invention is to provide an attachable glove accessory which can be added to a glove palm and adhered by adhesives or binding strips.

Yet another object of the invention is to create a hand sanitizer imbued pad which is activated by removing a plastic outer casing or sheet.

### SUMMARY OF THE INVENTION

The invention is a spongy open cell foam pad which has been soaked in hand sanitizer and attached to the palm of a glove in a configuration which does not impede or constrict hand movement.

### DETAILED DESCRIPTION OF THE INVENTION

An open cell foam is saturated with hand sanitizer solution and attached to the palm of a glove and used as a reservoir for time release hand sanitizer.

### Examples of the Invention

In one preferred embodiment, cellulose sponge is formed into a deformed triangular configuration at 0.5 inches of profile thickness and 4.5 inches squared of surface area. Hot-melt adhesive is used to adhere the pad to the palm surface of a glove. The hand sanitizer imbued foam pad is covered with polyethylene film until ready for use. The polyethylene film is pulled away and the hand sanitizer is available for release onto the finger tips of the glove.

In another preferred embodiment, a polyethylene open cell foam is saturated with hand sanitizer and adhered to a solid triangular thermoplastic backing. The thermoplastic surface facing away from the foam material has adhesive strips attached so that the foam pad can be replaced. The hand sanitizer can be added from a dropper bottle or pre-added and protected by a thermoplastic shield which is removed prior to use by the glove owner.

What is claimed:

1. A palm sized open-cell foam pad which is attached to a glove and saturated with liquid hand sanitizer.

2. The claim in 1 where the foam is an elastomeric polymer.

3. The claim in 1 where the foam is made from cellulose fibers.

4. The claim in 2 where the foam is a thermo-set polymer.

5. The claim in 2 where the foam is a thermoform polymer.

6. The claim in 1 where the pad is pre-wetted with hand sanitizer and covered with a removable film prior to product use.

7. The claim in 1-6 where the hand sanitizer is encapsulated on a support media inside the foam and released upon use.

8. The claim in 1 where the pad is made from natural sponge.

9. The claim in 4 where the sponge is made from polyvinylacetate.

10. The claim in 4 where the sponge is made from polyurethane.

11. The claim in 1 where the pad is made from polyester.

12. The claim in 1 where the pad is made from cellulose acetate.

13. The claim in 1 where the pad is made from silicone.

14. The claim in 1 where the pad is made from epoxy resin.

15. The claim in 1 where the pad is made from polyethylene.

16. The claim in 1 where the pad is made from polystyrene.

17. The claim in 1 where the pad is made from latex foam rubber.

18. The claim in 1 where the pad is made from natural rubber.

19. The claim in 1 where the pad is made from biodegradable polymer.
